(19) United States
(12) Patent Application Publication
(10) Pub. No.: US 2026/0319084 A1
(43) Pub. Date: Oct. 15, 2026

(54) METHOD OF ESTIMATING A MOVING DIRECTION OF A FORWARD VEHICLE USING RADAR AND APPARATUS FOR THE SAME

(71) Applicant: CHUNG ANG UNIVERSITY INDUSTRY ACADEMIC COOPERATION FOUNDATION, Seoul (KR)

(72) Inventors: Seong Wook LEE, Seoul (KR); Ho Jung LEE, Gwangmyeong-si (KR)

(21) Appl. No.: 19/452,350

(22) Filed: Jan. 18, 2026

Related U.S. Application Data
(63) Continuation of application No. PCT/KR2024/002208, filed on Feb. 21, 2024.

(30) Foreign Application Priority Data
Jul. 27, 2023 (KR) 10-2023-0097899

(51) Int. Cl. G01S 13/58; G01S 7/35; G01S 7/41; G01S 13/89; G01S 13/931

(52) U.S. Cl. CPC G01S 13/583; G01S 7/356; G01S 7/417; G01S 13/89; G01S 13/931

(57) ABSTRACT

A method of estimating a moving direction of a forward vehicle using radar comprises: (a) acquiring a radar detection result and then performing signal processing to respectively acquire forward vehicle information; (b) converting the forward vehicle information into point cloud data in a 2D space; (c) preprocessing the point cloud data and converting the same into an image; and (d) applying the converted image to a trained deep learning model and outputting traveling direction and angle information of a forward vehicle.

### CROSS-REFERENCES TO RELATED APPLICATION

This application is a bypass continuation of pending PCT International Application No. PCT/KR2024/002208, which was filed on Feb. 21, 2024, and which claims priority to Korean Patent Application No. 10-2023-0097899, which was filed in the Korean Intellectual Property Office on Jul. 27, 2023. The disclosures of which are hereby incorporated by reference in their entireties.

### TECHNICAL FIELD

The present disclosure relates to a method of estimating a traveling direction of a forward vehicle using only radar reception signals, and an apparatus therefor.

### BACKGROUND ART

Recently, demand for autonomous driving vehicles that can safely navigate complex and dynamic road environments has been increasing. Autonomous driving vehicles can recognize the surrounding environment by using various types of sensors such as cameras, lidars, and radars. These sensors must operate accurately in any situation in order to ensure the safety of a driver, however, under low-illumination conditions including nighttime or environments with heavy fog, there is a problem in that the performance of a camera deteriorates. A lidar sensor also has the same problem as a camera under inclement weather such as snow, rain, and fog.

In addition, when a vehicle cuts in from the front while driving, a rear-end collision may occur due to problems such as absence of nighttime lighting facilities, difficulty in securing visibility due to fog, or carelessness of a driver.

Radar has an advantage in that it can operate stably regardless of weather conditions or lighting conditions, but radar mounted on a vehicle has been limited to research on obstacle detection and distance estimation.

### DISCLOSURE

### Technical Problem

The present disclosure is to provide a vehicle moving direction estimation method using radar and an apparatus therefor.

In addition, the present disclosure is to provide a vehicle moving direction estimation method and an apparatus therefor, which can estimate a traveling direction and an accurate angle of a forward vehicle using only radar reception signals.

### Technical Solution

According to one aspect of the present disclosure, a method of estimating a moving direction of a forward vehicle using radar and apparatus for the same is provided.

According to an embodiment of the present disclosure, A vehicle moving direction estimation method using radar, comprising: (a) acquiring a radar detection result and then performing signal processing to respectively acquire forward vehicle information; (b) converting the forward vehicle information into point cloud data in a 2D space; (c) preprocessing the point cloud data and converting the same into an image; and (d) applying the converted image to a trained deep learning model and outputting traveling direction and angle information of a forward vehicle.

In step (b), results for 10 frames of the forward vehicle information may be accumulated and converted into point cloud data by converting the accumulated results into a single XY coordinate system.

In step (c), the point cloud data may by resized to a size of 100× 100 and converting the same into an image.

The forward vehicle information is distance and angle information, and is converted into point cloud data in a 2D space by using the following mathematical expression,

xₖ=Rₖ cos θ_{k,e} sin θ_{k,a},

yₖ=Rₖ cos θ_{k,e} cos θ_{k,a},

Here, Rt denotes a distance to a k-th target, denotes an azimuth angle to the k-th target, denotes an elevation angle to the k-th target, and k is a natural number.

According to another aspect of the present disclosure, a vehicle moving direction estimation apparatus using radar is provided.

According to an embodiment of the present disclosure, a vehicle moving direction estimation apparatus using radar, comprising: a radar sensor configured to acquire a radar detection result; a signal processor configured to perform signal processing on the radar detection result to respectively acquire forward vehicle information; a converter configured to convert the forward vehicle information into point cloud data in a 2D space; a preprocessor configured to preprocess the point cloud data and convert the same into an image; and an estimator configured to apply the converted image to a trained deep learning model and output traveling direction and angle information of a forward vehicle.

The converter may accumulate results for 10 frames of the forward vehicle information, convert the accumulated results into one XY coordinate system, and convert the same into point cloud data.

The preprocessor may resize the point cloud data to a size of 100×100 and convert the same into an image.

### Advantageous Effects

According to an embodiment of the present disclosure, by providing a vehicle moving direction estimation method using radar and an apparatus therefor, it is possible to estimate a traveling direction and an accurate angle of a forward vehicle using only radar reception signals.

### BRIEF DESCRIPTION OF THE DRAWINGS

FIG. 1 is a flowchart illustrating a vehicle moving direction estimation method using radar according to an embodiment of the present disclosure.

FIG. 2 is a diagram schematically illustrating a radar system according to an embodiment of the present disclosure.

FIG. 3 is a diagram illustrating an FMCW radar transmission signal according to an embodiment of the present disclosure.

FIG. 4 is a diagram illustrating distance and velocity estimation according to an embodiment of the present disclosure.

FIG. 5 is a diagram illustrating a data cube according to an embodiment of the present disclosure.

FIG. 6 is a diagram illustrating channel selection for azimuth angle estimation in a data cube according to an embodiment of the present disclosure.

FIG. 7 is a diagram illustrating preprocessing of point cloud data according to an embodiment of the present disclosure.

FIG. 8 is a diagram illustrating a structure of a deep learning model according to an embodiment of the present disclosure.

FIG. 9 is a diagram illustrating training of a deep learning model according to an embodiment of the present disclosure.

FIG. 10 is a block diagram schematically illustrating an internal configuration of a moving direction estimation apparatus according to an embodiment of the present disclosure.

FIG. 11 is a diagram illustrating radar specifications according to an embodiment of the present disclosure.

FIG. 12 is a diagram illustrating a result of orthogonally projecting a 3D point cloud onto an XY plane according to an embodiment of the present disclosure.

### BEST MODE

In the present specification, singular forms include plural forms unless the context clearly indicates otherwise. In the specification, the terms “composed of” or “include,” and the like, should not be construed as necessarily including all of several components or several steps described in the specification, and it should be construed that some component or some steps among them may not be included or additional components or steps may be further included. In addition, the terms “ . . . unit”, “module”, and the like disclosed in the specification refer to a processing unit of at least one function or operation and this may be implemented by hardware or software or a combination of hardware and software.

Hereinafter, the embodiments of the present disclosure will be described in detail with reference to the accompanying drawings.

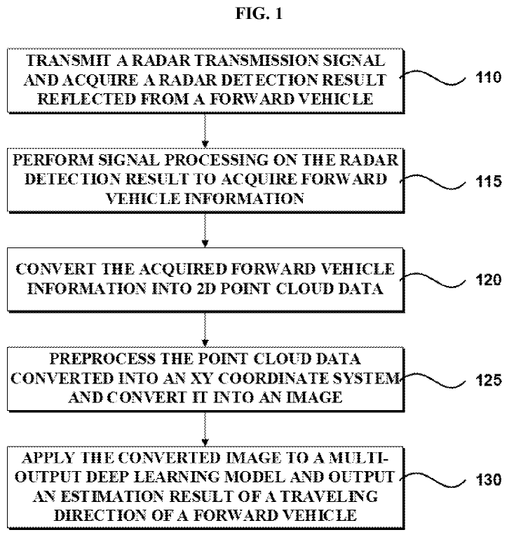

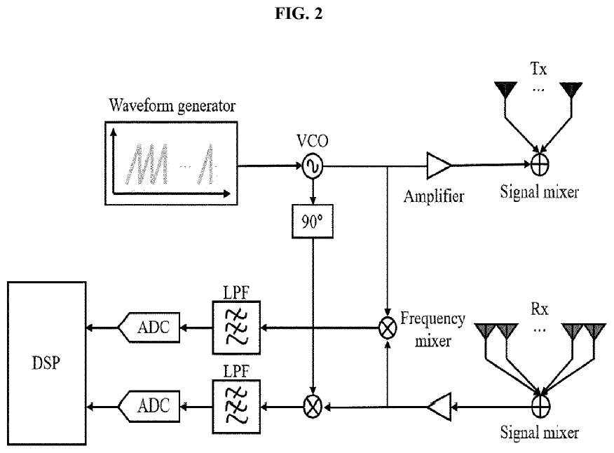

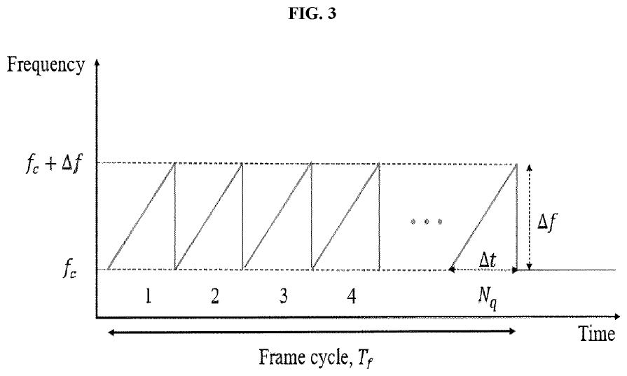

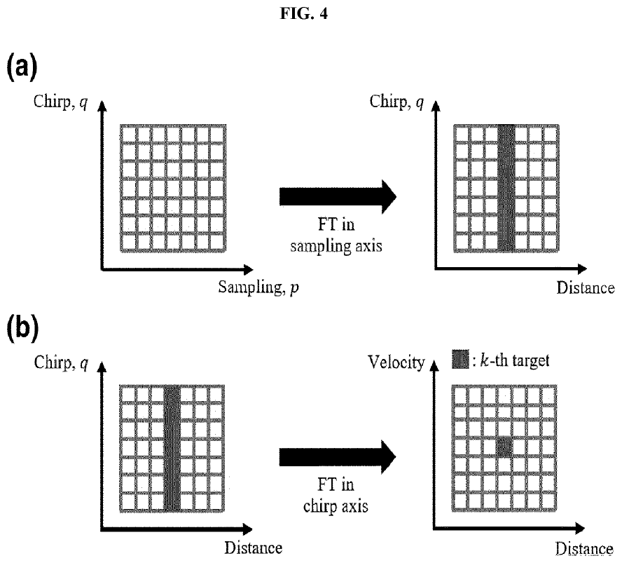

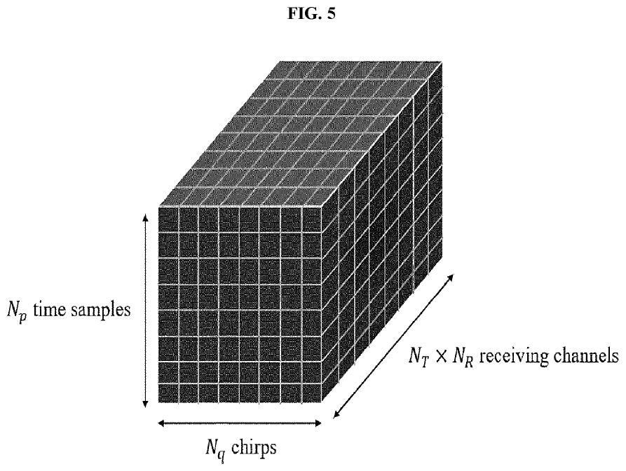

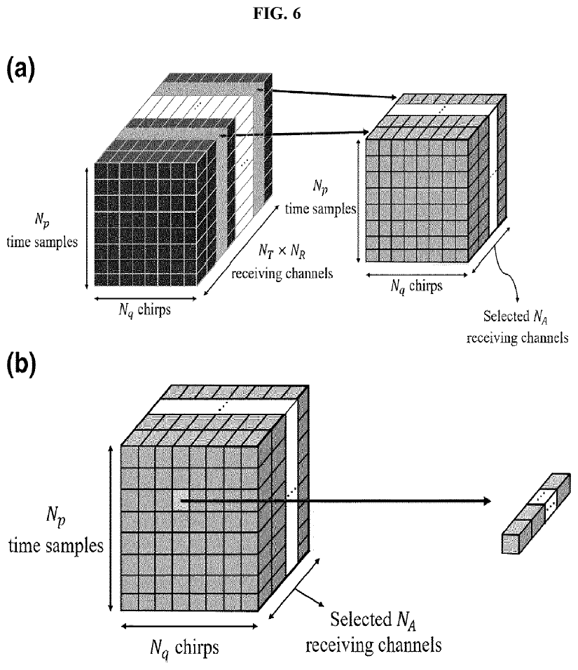

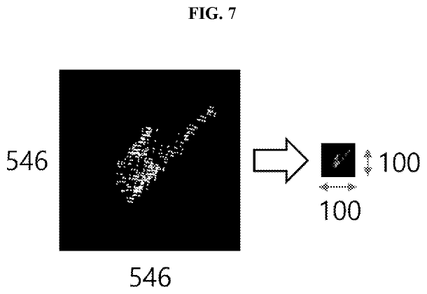

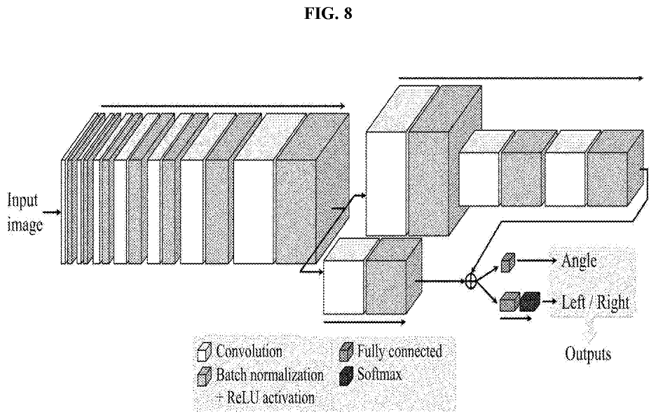

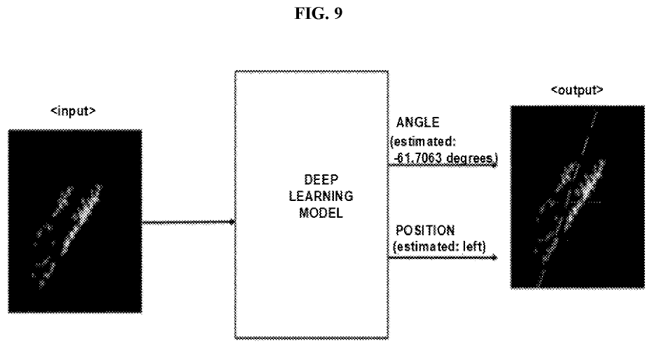

FIG. 1 is a flowchart illustrating a vehicle moving direction estimation method using radar according to an embodiment of the present disclosure, FIG. 2 is a diagram schematically illustrating a radar system according to an embodiment of the present disclosure, FIG. 3 is a diagram illustrating an FMCW radar transmission signal according to an embodiment of the present disclosure, FIG. 4 is a diagram illustrating distance and velocity estimation according to an embodiment of the present disclosure, FIG. 5 is a diagram illustrating a data cube according to an embodiment of the present disclosure, FIG. 6 is a diagram illustrating channel selection for azimuth angle estimation in a data cube according to an embodiment of the present disclosure, FIG. 7 is a diagram illustrating preprocessing of point cloud data according to an embodiment of the present disclosure, FIG. 8 is a diagram illustrating a structure of a deep learning model according to an embodiment of the present disclosure, FIG. 9 is a diagram illustrating training of a deep learning model according to an embodiment of the present disclosure.

In step 110, a moving direction estimation apparatus 100 acquires a radar detection result.

In step 115, the moving direction estimation apparatus 100 performs signal processing on the radar detection result to acquire forward vehicle information.

Here, the forward vehicle information may include a distance, a velocity, an azimuth angle, an elevation angle, and the like of the forward vehicle.

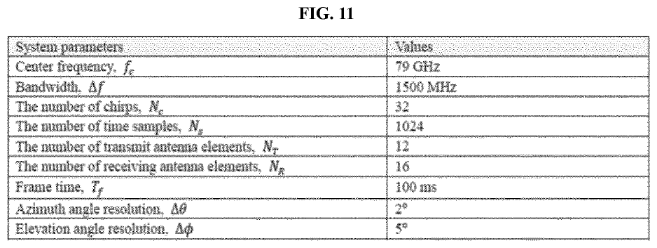

It is assumed that the moving direction estimation apparatus 100 described below is provided with an FMCW radar sensor as shown in FIG. 2. Specifications for the radar sensor are as shown in FIG. 11.

An FMCW radar sensor can simultaneously track a distance and a velocity to a forward vehicle. As shown in FIG. 3, N_{q} chirps, in each of which a frequency linearly increases with time, may be sequentially transmitted by the FMCW radar sensor. In FIG. 3, f_{c}, Δf, Δt represent a center frequency, an operating bandwidth, and a duration of each chirp, respectively. In addition, T_{f} represents an entire transmission period, which is defined as one frame.

If it is assumed that the transmitted FMCW radar signal is reflected by a k-th target (more specifically, a point target) moving at a relative velocity vₖ at a distance Rₖ a radar reception signal includes a time delay caused by the distance Rₖ between the radar and the k-th target and a Doppler shift caused by a velocity vₖ between the radar and the k-th target.

In addition, the Doppler shift may be expressed as fd, k=2vₖf_{c}/c, where c denotes the speed of light. The FMCW radar reception signal is down-converted to a baseband signal through a frequency mixer and an LPF (low pass filter), and a baseband signal sampled by an ADC (analog-to-digital converter) can be represented as Equation 1.

$$b [ p , q ] = {\sum }_{k = 1}^{{N}_{k}} {A}_{k} exp ( j 2 π ( \frac{2 {R}_{k} Δ f}{c Δ {tf}_{s}} p + \frac{2 {v}_{k} {f}_{c} Δ t}{c} q + \frac{2 {R}_{k} {f}_{c}}{c} ) ) , \qquad [ Equation 1 ]$$

Here, Nₖ represents a total number of points recognized as targets, Aₖ represents an amplitude of a baseband signal for a k-th target recognized as a target, and Rₖ and vₖ respectively represent a distance and a velocity between a k-th point recognized as a target and the radar. In Equation (1), p(p=1, 2, . . . , Nₚ) represents an index for time samples of each chirp, and q (q=1, 2, . . . , N_{q}) represents an index of each chirp. In addition, fₛ represents a sampling frequency, and Tₛ is a sampling period.

As shown in FIG. 2, an FMCW radar sensor is configured to include a waveform generator, a voltage controlled oscillator (VCO), an amplifier, a transmit antenna element (Tx) and a receive antenna element (Rx), a frequency mixer, a phase shifter, an LPF, an ADC, and a digital signal processor.

A time-sampled baseband signal of Equation 1 may be represented in a form of a 2D matrix as shown in (a) of FIG. 4. When Fourier transforms are respectively applied in a sampling-axis direction (that is, a p-axis) and in a chirp-axis direction (that is, a q-axis), a distance and a velocity to a forward vehicle may be estimated.

That is, when a 2D Fourier transform is applied to Equation 1, a distance and a velocity of a forward vehicle can be extracted at once. A result of performing a two-dimensional Fourier transform on Equation 1 can be expressed as Equation 2.

$$B [ r , s ] = \frac{1}{{N}_{p} {N}_{q}} {\sum }_{p = 1}^{{N}_{p}} {\sum }_{q = 1}^{{N}_{q}} b [ p , q ] \times exp ( - j 2 π ( \frac{{p}^{r}}{{N}_{p}} + \frac{{q}^{s}}{{N}_{q}} ) ) . \qquad [ Equation 2 ]$$

For angle estimation of the forward vehicle, a MIMO antenna system configured with multiple transmit and receive antenna elements may be used. If an azimuth angle and an elevation angle between an antenna center and a k-th target are assumed to be θₖ and φₖ; respectively, Equation 1 can be extended as Equation 3.

$$b [ p , q , u , v ] = {\sum }_{k = 1}^{K} {α}_{k} exp ( j 2 π ( \frac{2 {R}_{k} Δ f}{c Δ {tf}_{s}} p + \frac{2 {v}_{k} {f}_{c} Δ t}{c} q + \frac{{f}_{e} {d}_{t , a} sin {θ}_{k}}{c} ( n - 1 ) + \frac{{f}_{c} {d}_{r , d} sin {θ}_{k}}{c} ( v - 1 ) + \frac{{f}_{c} {d}_{t , c} sin {ϕ}_{k}}{c} ( u - 1 ) + \frac{{f}_{c} {d}_{r , c} sin {ϕ}_{k}}{c} ( v - 1 ) + \frac{2 {R}_{k} {f}_{c}}{c} ) ) , \qquad [ Equation 3 ]$$

Here, d_{t, a} and d_{t,e} represent distances between transmit antenna elements 4 and arranged in an azimuth direction and in an elevation direction, respectively. In addition, d_{r, a} and d_{r, e} represent distances between receive antenna elements arranged in the azimuth direction and the elevation direction. In addition, u(u=1,2, . . . , N_{T}) represents an index of a transmit antenna element. For example, in a MIMO antenna system in which the number of transmit antenna elements is N_{T} and the number of receive antenna elements is, N_{R}, the number of receive channels can virtually increase up to N_{T}×N_{R}. Since an angular resolution is proportional to the number of receive channels, by using the MIMO antenna system, a high angular resolution can be obtained with a limited device size.

When a total of N_{T}×N_{R} receive channels are generated, a total of N_{T}×N_{R} Fourier transform results of Equation 2 are generated. That is, Nₚ×N_{q}×(N_{T}×N_{R}) data cubes are generated and can be represented as shown in FIG. 5.

$${B}_{A} = [ \begin{matrix}{B}_{1} [ {r}_{k} , {s}_{k} ] \\ {B}_{2} [ {r}_{k} , {s}_{k} ] \\ ⋮ \\ {B}_{{N}_{A}} [ {r}_{k} , {s}_{k} ]\end{matrix} ] \qquad [ Equation 4 ]$$

In order to estimate an azimuth angle of the forward vehicle, among all virtual receive channels, receive channels arranged in an azimuth direction are selected. For example, when it is assumed that the number of channels in the azimuth direction is N_{A}, a data cube having a size of Nₚ×N_{q}×N_{A} can be generated as shown in (a) of FIG. 5. When indices corresponding to a k-th target in the 2D Fourier transform result of each channel are denoted by (\gamma_k) and (s_k), respectively, a total of (N_A) sampled values can be obtained as shown in (b) of FIG. 6. Accordingly, a signal vector composed of values sampled from the (N_A) channels can be represented as Equation 4.

Based on the signal vector of Equation 4, an existing beamformer, which is one of digital beamforming techniques, can be used for angle estimation. To this end, a correlation matrix may be generated by using the extracted signal vector of Equation 4, and this can be represented as Equation 5.

$${R}_{A} = \frac{1}{{N}_{A}} {B}_{A} {B}_{A}^{H} . \qquad [ Equation 5 ]$$

In Equation 5, (·)^{H} denotes a Hermitian operator, so R_{A} becomes a square matrix of size N_{A}×N_{A}.

A normalized pseudospectrum of the conventional beamformer can be represented as Equation 6.

$${P}_{A} ( θ ) = \frac{{a}_{A}^{H} ( θ ) {R}_{A} {a}_{A} ( θ )}{max ( {a}_{A}^{H} ( θ ) {R}_{A} {a}_{A} ( θ ) )} . \qquad [ Equation 6 ]$$

Here, a_{A}(θ) represents a steering vector that takes into account distances between receive channels in an azimuth direction, and an azimuth angle of a forward vehicle can be determined by θ that maximizes a value of the normalized pseudospectrum.

A process of estimating an elevation angle φₖ is similar to a process of estimating an azimuth angle θₖ. A difference from the azimuth angle estimation is that N_{E} receive channels are selected in an elevation direction, and distances between receive channels considered in a steering vector a_{E}(φ) are changed.

In step 120, a moving direction estimation apparatus 100 converts each extracted forward vehicle information into 2D point cloud data.

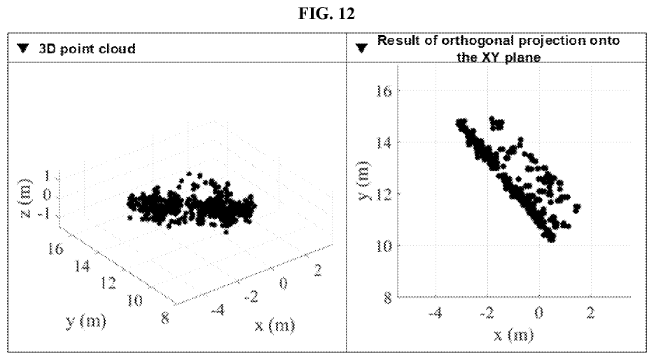

For example, when a detection result using a reception signal of a radar is represented in a three-dimensional coordinate system in a form of a point cloud, it is as shown in FIG. 12.

In FIG. 12, values that can be estimated by using the radar are Rₖ, θ_{k,a}, θ_{k,e}, which represent a distance to a k-th target, an azimuth angle of the k-th target, and an elevation angle of the k-th target, respectively. Here, k may be a natural number. By using these, coordinates (xₖ, yₖ, zₖ) in a three-dimensional space for the k-th target (for example, a forward vehicle) can be obtained, and when this is expressed as a mathematical expression, it is as shown in Equation 7.

xₖ=Rₖ cos θ_{k,e} sin θ_{k,a},yₖ=Rₖ cos θ_{k,e} cos θ_{k,a},zₖ=Rₖ sin θ_{k,e}, [Equation 7]

By using this, when a k-th point is orthogonally projected onto an XY plane, two-dimensional coordinates (xₖ, yₖ) can be obtained.

Accordingly, the moving direction estimation apparatus 100 can convert into point cloud data by representing in an XY coordinate system on the basis of forward vehicle information (that is, distance and angle information) using a relational expression such as Equation 7.

In an embodiment of the present disclosure, results for 10 frames (1 second) are accumulated, and they can be converted into an XY coordinate system by orthogonally projecting them onto an XY plane.

In step 125, the moving direction estimation apparatus 100 preprocesses the point cloud data converted into the XY coordinate system and converts it into an image.

For example, as shown in FIG. 7, point cloud data converted into the XY coordinate system may be resized to a size of 100×100 suitable for deep learning training and converted into an image. Of course, in converting the point cloud data into an image, a Density-Based Spatial Clustering of Applications with Noise (DBSCAN) clustering algorithm may be applied to the point cloud data to remove unnecessary portions such as noise around an object to be observed, and then the data may be converted into an image having one color (for example, black or white).

In addition, in order to convert two-dimensional data converted into the XY coordinate system into an image, the moving direction estimation apparatus 100 may first find a center of the data and then perform a preprocessing process of removing points other than a target by observing the same range in upper, lower, left, and right directions on the basis of the center.

Subsequently, in step 130, the moving direction estimation apparatus 100 applies the converted image to a multi-output deep learning model to generate a forward vehicle traveling direction estimation result. Here, the forward vehicle traveling direction estimation result includes a traveling direction and an angle.

At this time, a detailed structure of the multi-output deep learning model is as shown in FIG. 8.

The multi-output deep learning model may be trained, as shown in FIG. 9, to estimate a traveling direction of a forward vehicle up to angle information. Here, the traveling direction may be left or right.

For example, in the case of FIG. 9, the angle information may be 60 degrees, and since the angle information of the vehicle is 60 degrees, this means a vehicle approaching from a left side of the front. That is, it may be estimated as a vehicle traveling to the right.

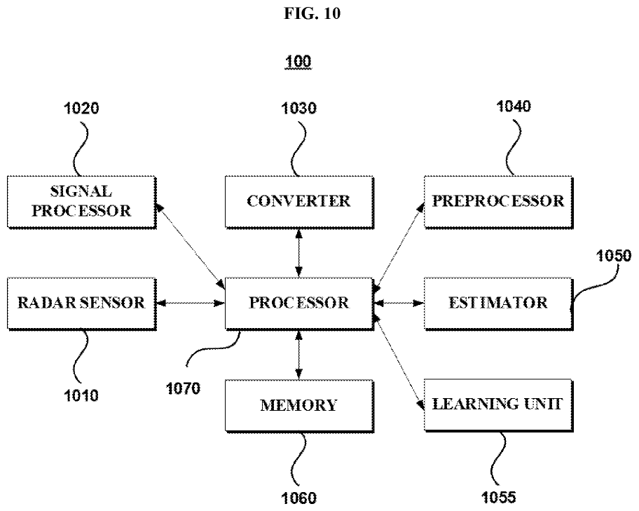

FIG. 10 is a block diagram schematically illustrating an internal configuration of a moving direction estimation apparatus according to an embodiment of the present disclosure.

Referring to FIG. 10, a moving direction estimation apparatus 100 according to an embodiment of the present disclosure is configured to include a radar sensor 1010, a signal processor 1020, a converter 1030, a preprocessor 1040, an estimator 1050, a learning unit 1055, a memory 1060, and a processor 1070.

The radar sensor 1010 is a means for transmitting a radar transmission signal and then acquiring a radar detection result reflected by a target (forward vehicle).

The signal processor 1020 is a means for performing signal processing on the radar detection result to respectively acquire forward vehicle information. Here, the forward vehicle information may be a distance and an angle.

The converter 1030 is a means for converting the forward vehicle information into x and y coordinates in a 2D space and converting the same into point cloud data for each forward vehicle.

The preprocessor 1040 is a means for preprocessing point cloud data and converting the same into an image. For example, the preprocessor 1040 may resize the point cloud data to a size of 100×100 and convert it into an image suitable for training of a deep learning model.

The estimator 1050 is a means for applying the converted image to a deep learning model to estimate a traveling direction and an angle of the forward vehicle. Here, it is assumed that the deep learning model is pre-trained, by using training data, to estimate the traveling direction and the angle.

A learning unit 1055 is a means for training the deep learning model to estimate a traveling direction and an angle of the forward vehicle by using a training data set. The training data set includes ground-truth labels. Accordingly, the learning unit 1055 may train the deep learning model by updating learning parameters of the deep learning model so that a difference between the ground-truth labels and the estimated traveling direction and angle is minimized.

The memory 1060 stores program code for performing a vehicle moving direction estimation method using radar according to an embodiment of the present disclosure.

The processor 1070 is a means for controlling internal components (for example, the radar sensor 1010, the signal processor 1020, the converter 1030, the preprocessor 1040, the estimator 1050, the learning unit 1055, the memory 1060, etc.) of the vehicle moving direction estimation apparatus 100 using radar according to an embodiment of the present disclosure.

The apparatus and method according to embodiments of the present disclosure may be implemented in the form of program instructions executable by various computer means and recorded on a computer-readable medium. The computer-readable medium may include, alone or in combination, program instructions, data files, and data structures. The program instructions recorded on the computer-readable medium may be specially designed and configured for the present disclosure, or may be known and available to those skilled in the art of computer software.

Examples of the computer-readable recording medium include magnetic media such as hard disks, floppy disks, and magnetic tapes; optical media such as CD-ROMs and DVDs; magneto-optical media such as floptical disks; and hardware devices specially configured to store and execute program instructions, such as ROM, RAM, and flash memory. The program instructions include not only machine code generated by compilers, but also high-level language code that can be executed by a computer using interpreters or the like.

The foregoing hardware devices may be configured to operate as one or more software modules to perform the operations of the present disclosure, and vice versa.

Hereinabove, the present disclosure has been described with reference to exemplary embodiments thereof. It will be understood by those skilled in the art to which the present disclosure pertains that the present disclosure may be implemented in a modified form without departing from essential characteristics of the present disclosure. Therefore, the exemplary embodiments disclosed herein should be considered in an illustrative aspect rather than a restrictive aspect. The scope of the present disclosure should be defined by the claims rather than the above-mentioned description, and all differences within the scope equivalent to the claims should be interpreted to fall within the present disclosure.

What is claimed is:

1. A vehicle moving direction estimation method using radar, comprising:
(a) acquiring a radar detection result and then performing signal processing to respectively acquire forward vehicle information;
(b) converting the forward vehicle information into point cloud data in a 2D space;
(c) preprocessing the point cloud data and converting the point cloud data into an image; and
(d) applying the converted image to a trained deep learning model and outputting traveling direction and angle information of a forward vehicle.

2. The method of claim 1,
wherein step (b) comprises accumulating results for 10 frames of the forward vehicle information, converting the accumulated results into one XY coordinate system, and converting the same into point cloud data.

3. The method of claim 1,
wherein step (c) comprises resizing the point cloud data to a size of 100×100 and converting the same into an image.

4. The method of claim 1,
wherein the forward vehicle information is distance and angle information, and is converted into point cloud data in a 2D space by using the following mathematical expression.
xₖ=Rₖ cos θ_{k,e} sin θ_{k,a},
yₖ=Rₖ cos θ_{k,e} cos θ_{k,a},
wherein, Rₖ denotes a distance to a k-th target, θ_{k,a} denotes an azimuth angle to the k-th target, θ_{k,e} denotes an elevation angle to the k-th target, and k is a natural number.

5. A non-transitory computer-readable recording medium having recorded thereon program code that, when executed by a process, cause the process to perform the method of claim 1.

6. A vehicle moving direction estimation apparatus using radar, comprising:
a radar sensor configured to acquire a radar detection result;
a signal processor configured to perform signal processing on the radar detection result to respectively acquire forward vehicle information;
a converter configured to convert the forward vehicle information into point cloud data in a 2D space;
a preprocessor configured to preprocess the point cloud data and convert the point cloud data into an image; and
an estimator configured to apply the converted image to a trained deep learning model and output traveling direction and angle information of a forward vehicle.

7. The apparatus of claim 6,
wherein the converter is configured to accumulate results for 10 frames of the forward vehicle information, convert the accumulated results into one XY coordinate system, and convert the same into point cloud data.

8. The apparatus of claim 6,
wherein the preprocessor is configured to resize the point cloud data to a size of 100×100 and convert the same into an image.
